(19) United States
(12) Patent Application Publication
(10) Pub. No.: US 2006/0023848 A1
(43) Pub. Date: Feb. 2, 2006

(54) Enhanced interface for emergency communications

(76) Inventors: Bridget Mohler, Arvada, CO (US); David Mohler, Arvada, CO (US)

Correspondence Address: AVAYA INC., 307 MIDDLETOWN-LINCROFT ROAD, ROOM 1N-391, LINCROFT, NJ, 07738, US

(21) Appl. No.: 10/903,579

(22) Filed: Jul. 30, 2004

(51) Int. Cl. H04M 11/04

(52) U.S. Cl. 379/41; 379/45

(57) ABSTRACT

An enhanced user interface of a communications terminal, for effecting emergency communications. If the communications channel from the terminal is busy when the emergency communication is attempted, the interface frees up the channel and then effects the emergency communication. In response to detecting answer of the emergency communication or detecting a command from a user, the interface retrieves emergency-related information from a memory associated with the terminal and either displays it to the user or sends it to the emergency-response center via the call. The displayed information is a list of commands and corresponding emergency descriptions, such as icons of the corresponding emergencies. In response to the user's selection of one of the commands, the interface sends the selected command or the corresponding description to the emergency-response center.

### TECHNICAL FIELD

This invention relates to generally to communications arrangements for communicating emergencies, such as the US “911” emergency-call system, and relates specifically to user interfaces for such systems.

### BACKGROUND OF THE INVENTION

The capabilities of the US “911” emergency-call system have continuously been enhanced over the years. For example, the current standard of the 911 system, known as the Enhanced 911, or E911, system automatically provides the emergency response personnel with the phone number and address of the caller. An enhancement of this feature provides the emergency-response personnel with this information even for calls to the emergency center that have been abandoned before being answered, and automatically calls back the calling number. Yet another feature, the E911 Silent Call Feature, ensures equal access to the emergency telephone network for callers who, for whatever reason, cannot speak aloud. They can communicate their emergency needs by pressing specific keys on the telephone dial pad. For example, pressing “1” tells the emergency operator that the caller needs police, pressing “2” means fire, and pressing “3” indicates need for medical assistance. If the caller cannot speak because of a disability or the situation they are in, such as a home invasion or abuse, the emergency operator who receives a silent call can ask the caller a series of questions about the situation which the caller can answer by use of the keypad. For example, pressing “4” means “yes,” and pressing “5” means “no.”

Yet, there are situations where even these enhanced emergency-call features fall short of what is needed to quickly and effectively communicate emergency-related information to the emergency response center. For example, a hearing-impaired caller who lacks access to a TTY/TDD terminal at the time of the emergency call is not adequately served by the E911 Silent Call Feature, because that caller cannot hear and therefore cannot respond to the emergency operator's questions. Another problem arises in the case where a person is using the phone to access another service, such as a voice-messaging system, for example, when he or she suffers a sudden severe emergency, such as a heart attack. Hanging up, waiting for dial-tone, and dialing 911 could take enough time so that the person is not able to complete the process.

Yet another problem arises in the case of mobile telephone users who must interact with the emergency operator to identify their exact location, but are prevented by the emergency from engaging in such interaction. Some automobiles provide integration of the vehicle's systems (e.g., navigation, air-bag deployment) with the mobile telephone to automatically place an emergency call in the case of an accident and report the automobile's location. An example thereof is the General Motors OnStar system. But not all automobiles or mobile telephones have such capability.

### SUMMARY OF THE INVENTION

This invention is directed to solving these and other problems and disadvantages of the prior art. According to one aspect of the invention, when a communication is effected from a user terminal to an emergency-response center, emergency-related information is retrieved from a memory associated with the terminal and the retrieved information is presented to the user of the terminal or is transmitted via the communication to the emergency-response center. According to another aspect of the invention, the presented information comprises a list of commands and corresponding emergency-related information. When the user selects one of the commands, the command or the corresponding emergency-related information is transmitted via the communication to the emergency-response center. According to yet another aspect of the invention, when the emergency communication is attempted at the user terminal it is automatically (i.e., without intervention of the user) determined if the communication channel that is to be used for the communication is busy, and if so, the channel is automatically freed up. The communication is then automatically effected via the channel.

While the invention has been characterized in terms of actions, it also encompasses apparatus that performs those actions. The apparatus preferably includes an effector—any entity that effects the corresponding action, unlike a means—for each action. The invention further encompasses any computer-readable medium containing instructions which, when executed in a computer, cause the computer to perform the actions.

### BRIEF DESCRIPTION OF THE DRAWING

These and other features and advantages of the invention will become more apparent from the following description of an illustrative embodiment of the invention considered together with the drawing, in which:

FIG. 1 is a block diagram of an emergency-response communications system that includes an illustrative embodiment of the invention;

FIG. 2 is a functional flow diagram of a first aspect of the invention implemented by the system of FIG. 1;

FIG. 3 is a functional flow diagram of a second aspect of the invention implemented by the system of FIG. 1; and

FIG. 4 is a functional flow diagram of a third aspect of the invention implemented by the system of FIG. 1.

### DETAILED DESCRIPTION

FIG. 1 shows an emergency-response communications system, such as an E911 system. It comprises one or more user communications terminals 100, such as a wired or wireless telephone, communications-enabled personal digital assistant (PDA), softphone-equipped personal computer, remote burglar-alarm keypad and display, etc., that are connected via a communications network 120, such as the public telephone network, a private telephone network, a local area network, the Internet, etc., to an emergency-response center 130, such as an E911 PSAP, a private alarm company, an OnStar service center, etc. As described so far, the system of FIG. 1 is conventional.

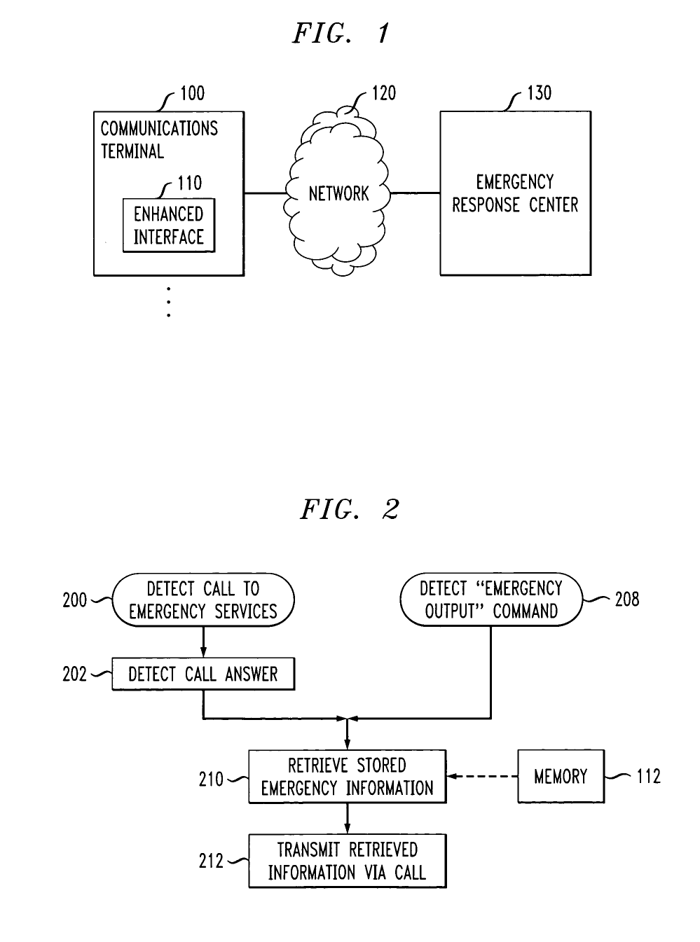

User communications terminal 100 is a computerized (program-controlled) device. According to the invention, terminal 100 is equipped with an enhanced interface 110 for making emergency calls. Enhanced interface 110 makes use of components of the conventional user interface of terminal 100, such as keys and other actuators, and a display. These components may be supplemented with additional components dedicated to enhanced interface 110. However, functionality of interface 110 is preferably primarily program-implemented. According to one aspect of the invention, shown in FIG. 2, enhanced interface 110 includes a memory 112 which stores any desired emergency-related information, such as the number and identities of occupants of the household in which terminal 100 is located, or information about previous emergencies or crimes at that location, or medical information about a user of terminal 100. Memory 112 may store this information either in audio, data or text form. If the information is stored in text form, terminal 100 preferably includes a text-to-speech (TTS) function (not shown). Interface 110 preferably monitors telephone numbers dialed from terminal 100. If and when it detects the dialing of an emergency number, such as “911,” at step 200, it monitors the call to detect if and when the call is answered, at step 202. Upon detecting call answer, interface 110 retrieves the emergency information that is stored in memory 112, at step 210, and sends out the retrieved information via the call, at step 212. If the stored information is in text form, interface 110 may process the information through the text-to-speech function to convert it into audio form before sending it out via the call. Similarly, speech-to-text functionality may be used to silently scroll the emergency operator's responses. If the stored information is data of some sort, interface 110 may process the information into a desired form before sending it out via the call.

In an alternative embodiment, interface 110 skips steps 200-202 and instead relies upon the caller to input a command, at step 208, directing interface 110 to retrieve and send the emergency information at steps 210-212.

The information sent out by interface 110 may indicate, or even automatically select, the mode of communication from the emergency response center back to the caller, e.g., voice, display, messaging, etc. For example, the sent-out information may advise emergency-response center 130 that the caller is hearing-impaired and that communicating with the caller requires the use of a TTY/TDD, causing center 130 to connect a TTY/TDD to the call and communicate with the caller therethrough.

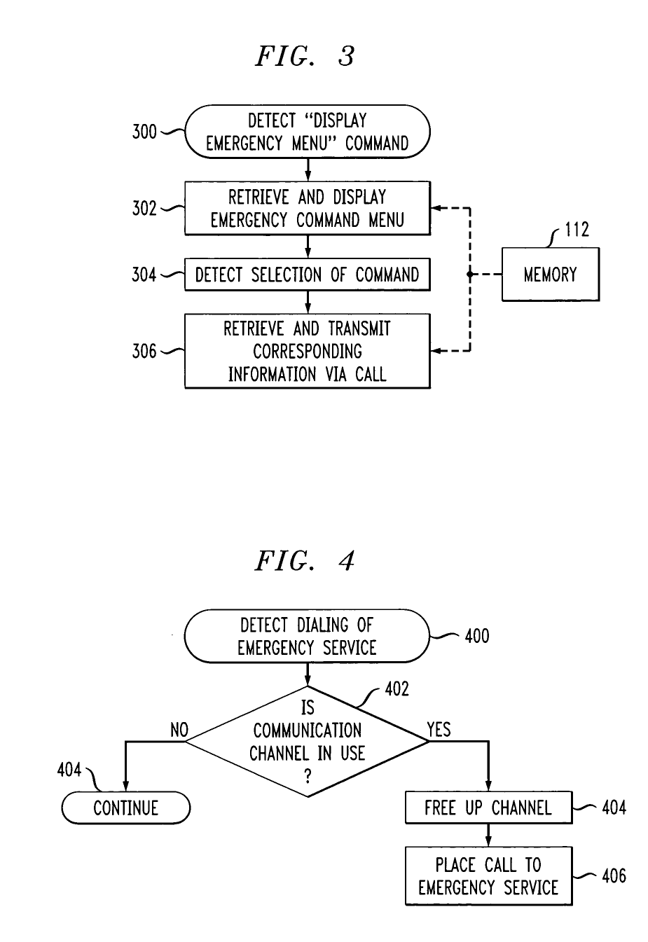

According to another aspect of the invention, shown in FIG. 3, memory 112 stores a menu of emergency commands that may be selected by a user of terminal 100, and optionally as other information as well, such as directions to the nearest exit from the facility, for example. When the user of terminal 100 makes an emergency call and enters a “display emergency menu” command on terminal 100, at step 300, interface 110 responds to this command by retrieving the menu of emergency commands and other information from memory 112 and displaying the retrieved menu and other information on a display screen (not shown) of terminal 110, at step 302. The displayed commands are preferably ordered according to the likelihood of their selection, so that the user has to do as little scrolling as possible to get to the desired command. For example, a user with a serious medical condition may have a “medical emergency” command displayed as the first command in the menu, as that is the most-likely command for them to select. If terminal 100 is a wired terminal, this user may have “fire” as the second command in the menu, as that emergency is likely to require them to leave terminal 100 behind and evacuate the premises most quickly. Furthermore, the displayed commands may be accompanied by displayed icons that indicate the meaning of the corresponding commands to non-native-language (e.g., non-English) speakers. The user then selects a command from the displayed menu that corresponds to their emergency and enters it on the dial keypad of terminal 100, whereupon that command is sent to emergency-response center 130. But this requires the center to be equipped with the Silent Call Feature, described above, where the commands are predetermined for the entire system of FIG. 1 so that center 130 understands the meaning of the command. It is therefore preferable that, instead of transmitting the command selected by the user, interface 110 detects the selection of the command, of step 304, and responds thereto by retrieving from memory 112 the information that corresponds to the command, i.e., the meaning of the command, such as an identification of the type of emergency being experienced by the user, and sending this corresponding information via the call to center 130, at step 306.

Yet another aspect of the invention deals with the situation where the communications channel is occupied, e.g., the telephone line is in use, when a user of terminal 100 attempts to make an emergency call. There are various scenarios when this may happen. For example, terminal 100 may share use of the communication channel with another device, such as a fax machine or a modem-equipped computer. Or, some external service may make use of the communication channel, such as a utility company using it to remotely read a utility meter, or an alarm company performing periodic remote continuity or equipment tests. Or, the user may be using terminal 100 to communicate with a voice-messaging system when an emergency occurs. According to this aspect of the invention, a user dials the emergency service number on terminal 100 regardless of whether or not the communications channel is busy. Interface 110 monitors all dialing on terminal 100, and when it detects the dialing of an emergency-service call, e.g., “911,” at step 400, it checks whether the communications channel is in use, at step 402. If the channel is free, interface 110 continues normal operations, at step 404. But if the channel is in use, interface 110 automatically frees up the channel, illustratively by sending the necessary electrical or data signals on the channel to “hang up” any other call that is using the channel, at step 404, and then places the emergency call on the freed-up channel, at step 406.

Of course, various changes and modifications to the illustrative embodiments described above will be apparent to those skilled in the art. For example, the emergency information may be sent to other destinations—to a doctor or a hospital, for example—in addition to an E911 facility. Medical-profile information may be added in secondary communication to a doctor or a hospital. Or, the invention may be applied to other emergency systems, such as reverse-911 systems that broadcast emergency calls from a central location, NOAA warning systems, etc. Such changes and modifications can be made without departing from the spirit and the scope of the invention and without diminishing its attendant advantages. It is therefore intended that such changes and modifications be covered by the following claims except insofar as limited by the prior art.

What is claimed is:

1. A method comprising:
effecting a communication to an emergency-response center from a user terminal;
retrieving emergency-related information from a memory associated with the user terminal; and
presenting the retrieved information to a user of the terminal or transmitting the retrieved information via the communication to the emergency-response center.

2. The method of claim 1 wherein:
the communication is a telephone call.

3. The method of claim 1 wherein:
the communication is a data communication.

4. The method of claim 1 wherein:
transmitting comprises
detecting that the communication has been answered at the center or detecting a command from the user of the terminal; and
in response to the detecting, transmitting the retrieved information.

5. The method of claim 1 wherein:
presenting comprises
displaying the retrieved information to the user on a display of the user terminal.

6. The method of claim 1 wherein:
retrieving comprises
retrieving a list of commands and corresponding emergency-related information;
presenting comprises
presenting the list to the user; and
transmitting comprises
in response to the user selecting one of the presented commands, transmitting the selected command or the corresponding emergency-related information via the communication to the emergency-response center.

7. The method of claim 6 wherein:
the list of commands and corresponding emergency-related information comprises
a list of the commands and descriptions of corresponding emergencies.

8. The method of claim 7 wherein:
the descriptions of corresponding emergencies comprise
icons representing the corresponding emergencies

9. A method comprising:
detecting an attempted emergency communication at a user terminal;
in response to the detecting, automatically determining if a communication channel that is to be used for the communication is busy;
in response to determining that the channel is busy, automatically freeing up the channel; and
in response to determining that the channel is not busy or to freeing up of the channel, automatically effecting the communication via the channel.

10. The method of claim 9 wherein:
the channel is a telephone line, and
the communication is an emergency telephone call.

11. The method of claim 10 wherein:
freeing up the channel comprises
terminating any call existing on the telephone line; and
effecting the communication comprises
in response to receiving a dial tone, effecting the emergency telephone call on the telephone line.

12. A method comprising:
detecting an attempted emergency call at a user terminal;
in response to the detecting, determining if a communication channel used by the terminal is busy;
in response to determining that the channel is busy, freeing up the channel;
in response to determining that the channel is not busy or to freeing up of the channel, effecting the emergency call to an emergency-response center via the channel;
retrieving emergency-related information from a memory associated with the terminal; and
presenting the retrieved information to a user of the terminal or transmitting the retrieved information via the call to the emergency-response center; wherein
presenting comprises
presenting a list of commands and descriptions of corresponding emergencies to the user, and
in response to the user selecting one of the commands, transmitting the selected command or the corresponding description to the emergency-response center.

13. A computer-readable medium containing instructions which, when executed in a computer, cause the computer to perform the method of one of claims 1-12.

14. The medium of claim 13 for a computer that comprises the user terminal.

15. An apparatus that performs the method of one of claims 1-12.

16. The apparatus of claim 15 comprising the user terminal.
